(19) United States
(12) Patent Application Publication
(10) Pub. No.: US 2026/0358574 A1
(43) Pub. Date: Nov. 12, 2026

(54) Photonic Chip Having Chip Waveguide and Cavity Connectable with Chip External Waveguide

(71) Applicant: Infineon Technologies AG, Neubiberg (DE)

(72) Inventor: Horst Theuss, Wenzenbach (DE)

(21) Appl. No.: 19/665,049

(22) Filed: May 1, 2026

(30) Foreign Application Priority Data
May 7, 2025 (DE) 102025117381.8

(51) Int. Cl. G02B 6/42

(52) U.S. Cl. CPC G02B 6/4212; G02B 6/4214

(57) ABSTRACT

An optoelectronic device includes a photonic chip. The photonic chip includes a semiconductor body, a chip waveguide arranged at the semiconductor body, and a cavity in the semiconductor body and configured to accommodate a chip external waveguide so that, when the chip external waveguide is accommodated in the cavity, an optical coupling between the chip waveguide and the chip external waveguide is established.

### TECHNICAL FIELD

The present invention relates to an optoelectronic device and to a method of manufacturing an optoelectronic device.

### Background

A package, for instance for data communications applications, provides a physical containment for one or more electronic chips comprising one or more integrated circuit elements. Examples of integrated circuit elements of packages are a metal oxide semiconductor field effect transistor (MOSFET), an insulated-gate bipolar transistor (IGBT), and a diode. Such packages may rely on electric signal transmission.

Another approach for transmitting signals are optoelectronic devices relying on optical signal transmission. However, connection of optoelectronic devices are conventionally cumbersome.

### Summary

There may be a need for an efficiently connectable optoelectronic device.

According to an exemplary embodiment, an optoelectronic device is provided which comprises a photonic chip, said photonic chip comprising a semiconductor body, a chip waveguide arranged at the semiconductor body, and a cavity in the semiconductor body configured for accommodating a chip external waveguide so that, when the chip external waveguide is accommodated in the cavity, an optical coupling between the chip waveguide and the chip external waveguide is established.

According to another exemplary embodiment, a method of manufacturing an optoelectronic device is provided, wherein the method comprises providing a photonic chip having a semiconductor body, arranging a chip waveguide at the semiconductor body, and forming a cavity in the semiconductor body for accommodating a chip external waveguide so that, when the chip external waveguide is accommodated in the cavity, an optical coupling between the chip waveguide and the chip external waveguide is established.

According to an exemplary embodiment, an optoelectronic device has a photonic chip which may enable optical signal transmission and/or signal processing. The photonic chip may have a semiconductor body, for instance a silicon substrate. A chip waveguide which may allow optical signal propagation at the photonic chip may be provided on and/or in the semiconductor body, for instance integrally connected with the semiconductor body. In addition, at least one cavity may extend into the semiconductor body accessible from an exterior side of the semiconductor so that it may receive a chip external waveguide from outside, which may allow optical signal propagation from and/or to the photonic chip. Consequently, upon inserting the chip external waveguide in the cavity, the chip waveguide and the chip external waveguide may be automatically optically coupled with each other so as to be ready for optical signal transmission. In particular, an efficient fiber-to-photonic chip coupling may be established in a compact way. Optical signal loss at the optical interface between the waveguides may be strongly limited, suppressed or even eliminated, which may lead to high optical signal integrity. Complex optical coupling measures may become dispensable in view of said direct photonic chip-chip external waveguide coupling.

In the following, further exemplary embodiments of the optoelectronic device and the method will be explained.

In the context of the present application, the term “optoelectronic device” may particularly denote a device operating in the field of photonics. In particular, an optoelectronic device may comprise at least one electrical-to-optical and/or optical-to-electrical transducer or converter (for instance a photodiode). In particular, an optoelectronic device may detect and/or control light. Such light may be any form of electromagnetic radiation such as ultraviolet, infrared and/or visible light.

In the context of the present application, the term “chip” may in particular denote a component comprising a body or substrate, in particular a semiconductor substrate. In particular, at least one integrated circuit element may be formed in such a substrate. For instance, the chip may be a semiconductor chip. The chip may be an active electronic device. In particular, the chip may be a semiconductor chip having at least one integrated circuit element (such as a monolithically integrated photodiode, a transistor, etc.) in a surface portion thereof. Said surface portion may be denoted as active region of the chip. The chip may be a bare die or may be already packaged or encapsulated. Semiconductor chips implemented according to exemplary embodiments may be formed for example in silicon technology, gallium nitride technology, silicon carbide technology, etc.

In the context of the present application, the term “photonic chip” may particularly denote a chip providing a photonic function. A photonic chip may also be denoted as a photonic integrated circuit or integrated optical circuit. A photonic chip may comprise one or more photonic components that form a functioning circuit. A photonic chip may detect, generate, transport, and/or process optical radiation such as light. Photonic integrated circuits may use photons during operation. For example, a photonic chip may comprise a multiplexer, a modulator, a demodulator, etc.

In the context of the present application, the term “semiconductor body” may particularly denote a block or bulky structure of semiconductor material. When such a semiconductor body forms part of a chip, at least one integrated circuit element may be integrated in said semiconductor body, in particular in an active region thereof.

In the context of the present application, the term “waveguide” may particularly denote a physical structure that is configured for guiding electromagnetic waves by restricting the transmission of electromagnetic energy to a propagation direction defined by an optically transparent structure of said waveguide. The waveguide may be an optical waveguide for guiding optical electromagnetic radiation. For instance, a waveguide may comprise or may consist of an optical fiber. For example, a waveguide may comprise a core along which optical radiation propagates. Said core may be surrounded by a cladding for restricting propagation of the optical radiation along the core. An interface between core and cladding may define a transition between different values of the electric permittivity.

In the context of the present application, the term “chip waveguide” may particularly denote a waveguide forming part of the photonic chip. For instance, such a chip waveguide may be attached to or may be integrally formed with an exterior surface of a semiconductor body of the photonic chip. It may also be possible to monolithically integrate the chip waveguide with the semiconductor body of the photonic chip. For example, a chip waveguide may comprise materials such as silicon nitride, silicon oxide, etc.

In the context of the present application, the term “chip external waveguide” may particularly denote a waveguide being provided as an optical member separate from and optically couplable with the photonic chip. In particular, the chip external waveguide may be a separate waveguide structure, such as an optical fiber, which can be inserted into a cavity of a semiconductor body of a photonic chip.

In the context of the present application, the term “cavity” may particularly denote a hole or recess in the semiconductor body sized and dimensioned for accommodating a free end portion of an assigned chip external waveguide. In particular, shape and dimension of cavity and an end portion of a chip external waveguide may be formed to match with each other. A cavity may comprise a blind hole and/or a through hole.

In the context of the present application, the term “main surface” of a body may particularly denote the largest body surface or one of the largest body surfaces. For instance, a body (such as a semiconductor body or a photonic chip) may be cuboid or plate-shaped and may then have two opposing main surfaces separated by body material in a thickness direction and connected with each other by a circumferential edge.

In an embodiment, the optoelectronic device comprises the chip external waveguide inserted into the cavity so that an optical coupling between the chip waveguide and the chip external waveguide is established. The chip external waveguide may be detachably or permanently connected with the photonic chip. When photonic chip and chip external waveguide are connected, propagation of an optical light beam between chip waveguide and chip external waveguide may be enabled.

In an embodiment, the optoelectronic device comprises an optically transparent filling medium at least partially filling a gap between the chip external waveguide and the photonic chip. Filling such a gap with an optically transparent medium (such as an optically transparent resin) may reduce or even eliminate optical losses which may occur when an air gap remains in the cavity between chip waveguide and chip external waveguide. Advantageously, a dielectric permittivity of the optically transparent medium may differ by less than 10% from a dielectric permittivity of the chip waveguide and/or of the chip external waveguide. Adapted values of the dielectric permittivity may further suppress optical losses.

In an embodiment, an exterior part of the chip waveguide extends along an exterior surface of the semiconductor body. This may lead to a very short propagation path from the chip external waveguide via the chip waveguide up to an active region of the semiconductor body for processing of an optical signal, or in opposite direction.

In an embodiment, an interior part of the chip waveguide extends from the cavity through the semiconductor body up to an exterior surface of the semiconductor body. By extending from the cavity up to a main surface of the semiconductor body, the interior part of the chip waveguide may be made extremely short.

In an embodiment, the exterior part of the chip waveguide is optically and mechanically coupled with the interior part of the chip waveguide. For instance, the interior part and the exterior part may be integrally formed. This may lead to an efficient optical transmission through the interface between the exterior part and the interior part. Alternatively, the exterior part and the interior part may be formed as separate physical structures which may be optically coupled at an optical interface in between. A mirror or a grating may be arranged between the exterior and the interior part.

In an embodiment, the optoelectronic device comprises an angled optical interface, in particular comprising a mirror and/or a grating, optically coupling the exterior part of the chip waveguide with the interior part of the chip waveguide. For instance, the exterior part and the interior part may be oriented perpendicular to each other. While the interior part may extend vertically through the semiconductor body, the exterior part may extend along an exterior main surface of the semiconductor body.

In an embodiment, the chip waveguide has a diameter of less than 1 µm. For instance, the diameter of the chip waveguide may be even less than 0.5 µm. These dimensions may be without cladding of the chip waveguide. Additionally or alternatively, the chip external waveguide has a diameter of at least 5 µm. For instance, the diameter of the chip external waveguide may be at least 7 µm. These dimensions may be without cladding of the chip external waveguide. In particular, the diameter of the chip waveguide may be smaller than the diameter of the chip external waveguide. For instance, the diameter of the chip external waveguide may be at least three times of the diameter of the chip waveguide. Thus, a challenging optical coupling between these two different dimensions may be accomplished by the direct optical coupling at a bottom of the cavity.

In an embodiment, the chip external waveguide is surrounded by a cladding. Additionally or alternatively, the chip waveguide is surrounded by a cladding. The cladding of the chip external waveguide may have a larger diameter than the cladding of the chip waveguide. In an embodiment, the cladding of the chip waveguide may have a diameter of less than 10 µm. In an embodiment, the cladding of the chip external waveguide may have a diameter of at least 50 µm. The respective cladding may have the function of keeping a majority of the energy of an optical beam inside the chip waveguide or inside the chip external waveguide, respectively.

In an embodiment, the cavity and/or a free end of the chip external waveguide and/or a free end of a cladding surrounding the chip external waveguide has a frustoconical surface or has a cylindrical surface. For instance, a free end of the cladding may have a frustoconical shape while a free end of the chip external waveguide inside of said cladding may have a frustoconical or a cylindrical shape. A frustoconical geometry may accomplish an efficient optical transition between different dimensions of the chip external waveguide and the chip waveguide.

In an embodiment, part of a bottom surface of the cavity is defined by an end surface of the chip waveguide. This may simplify and render highly efficient an optical transition between chip waveguide and chip external waveguide inserted in the cavity.

In an embodiment, the cavity extends into the semiconductor body perpendicular to a main surface of the semiconductor body. This ensures a reliable and intuitive connection between chip external waveguide and semiconductor body and enables also short optical paths.

In an embodiment, the cavity and part of the chip waveguide are arranged at opposing main surfaces of the semiconductor body. In particular, the cavity may be arranged at the back side of the semiconductor body so that insertion of the chip external waveguide into the cavity does not involve the risk of a damage of an active region of the semiconductor body with at least one monolithically integrated circuit element at the front side due to the insertion procedure. At the same time, arranging at least part of the chip waveguide at the opposing main surface of the semiconductor may ensure a short optical path from a monolithically integrated circuit element up to the chip waveguide.

In an embodiment, said photonic chip further comprises a further chip waveguide arranged at the semiconductor body, and a further cavity in the semiconductor body configured for accommodating a further chip external waveguide so that, when the further chip external waveguide is accommodated in the further cavity, an optical coupling between the further chip waveguide and the further chip external waveguide is established. In particular, the chip external waveguide is inserted into the cavity so that an optical coupling between the chip waveguide and the chip external waveguide is established, and the further chip external waveguide is inserted into the further cavity so that an optical coupling between the further chip waveguide and the further chip external waveguide is established. Hence, a semiconductor body may comprise two or more cavities exposing two or more chip waveguides of a photonic chip. Correspondingly, two or more chip external waveguides may be inserted in parallel into said cavities so that two or more chip external waveguide-chip waveguide optical connections may be formed in the same photonic chip, preferably simultaneously.

In an embodiment, the optoelectronic device comprises an alignment carrier, for example a semiconductor alignment carrier, carrying the chip external waveguide and the further chip external waveguide so that the chip external waveguide and the further chip external waveguide are aligned with respect to the cavity and the further cavity, respectively. When multiple chip waveguide-chip external waveguide optical connections are to be formed simultaneously, a pre-alignment of the chip external waveguides carried by a common alignment wafer or the like may be advantageous. Due to said pre-alignment, an insertion of all chip external waveguides into the cavities of a photonic chip may be possible without alignment issues and in a quick manner.

In an embodiment, the semiconductor body and the alignment carrier comprise mutually adapted alignment structures. Such alignment structures may be for example recess and protrusion, two mutually attracting magnets, etc. Such alignment structure may simplify connection and may provide a pre-aligning function.

In an embodiment, the photonic chip comprises at least one integrated circuit element monolithically integrated in the semiconductor body. The at least one monolithically integrated circuit element may be formed in a front side of the semiconductor body. For instance, such an integrated circuit element may comprise an optical-to-electrical converter, an electrical-to-optical converter, a multiplexer, a modulator, a demodulator, an amplifier, a processor, a filter, etc.

In an embodiment, the photonic chip comprises an optoelectronic converter for converting between an electronic domain in the semiconductor body and an optical domain corresponding to the chip waveguide. For instance, such an optoelectronic converter may comprise a photodiode.

In an embodiment, at least one of the chip waveguide and the chip external waveguide comprises an optical fiber. In particular, an optical fiber may be a flexible glass or plastic fiber that can transmit optical light from one end to the other. Such fibers may be implemented in fiber-optic communications.

In an embodiment, the cavity is formed in the front side or in the back side of the photonic chip. While cavity formation on the back side may be advantageous in terms of a mechanical protection of the sensitive front side and the possibility to provide the chip waveguide at least partially on the front side and therefore close to an active region, cavity formation on the front side is also an option.

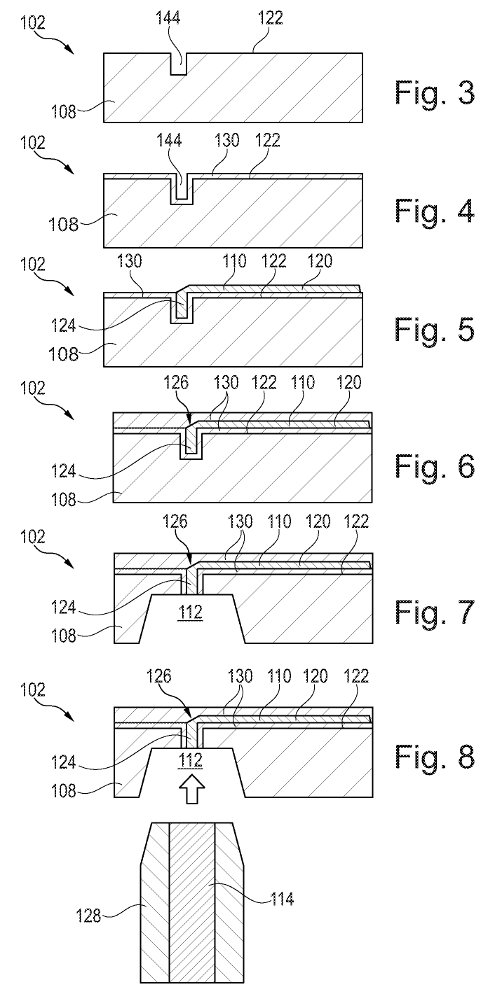

In an embodiment, the method comprises forming a trench in the semiconductor body, forming a portion of a cladding in the trench and on a main surface of the semiconductor body, forming the chip waveguide on the portion of the cladding in the trench and on the portion of the cladding on the main surface, and covering the chip waveguide and the portion of the cladding with a remaining portion of the cladding. An example of such an advantageous manufacturing process is shown in FIGS. 3-9. Such a manufacturing process may integrally connect chip waveguide and its cladding with the semiconductor body of the photonic chip. Advantageously, a compact design may be achieved, which may also lead to short optical paths and therefore a highly efficient optical transmission characteristics.

In an embodiment, the method comprises removing part of the portion of the cladding in the trench during forming the cavity in the semiconductor body until the chip waveguide is exposed in the cavity. By taking this measure, a flange face of the chip waveguide may be exposed upon formation of a cavity in the semiconductor body. This may significantly simplify and render failure robust an optical connection between the exposed flange face of the chip waveguide and a free end of a chip external waveguide to be inserted into the cavity for optical coupling with the chip waveguide.

As substrate or wafer forming the basis of the chip(s), a semiconductor substrate, preferably a silicon substrate, may be used. Alternatively, a silicon oxide or another insulator substrate may be provided. It is also possible to implement a germanium substrate or a III-V-semiconductor material. For instance, exemplary embodiments may be implemented in GaN or SiC technology.

The following additional aspects are disclosed as well:
Aspect 1. A photonic chip (102), comprising: a semiconductor body (108); and a chip waveguide (110) arranged at the semiconductor body (108) and being configured for being directly optically and mechanically coupled with a further chip waveguide (150) of a further photonic chip (104) so that, when the chip waveguide (110) is directly optically and mechanically coupled with the further chip waveguide (150), an optical coupling between the photonic chip (102) and the further photonic chip (104) is established.
Aspect 2. The photonic chip (102) according to aspect 1, wherein at least part of the chip waveguide (110) extends along an exterior surface (122) of the semiconductor body (108).
Aspect 3. The photonic chip (102) according to aspect 2, comprising one of the following features: wherein a free end (152) of the chip waveguide (110) protrudes beyond a sidewall (154) of the semiconductor body (108); wherein a free end (152) of the chip waveguide (110) is retracted with respect to a sidewall (154) of the semiconductor body (108); wherein a free end (152) of the chip waveguide (110) is in flush with a sidewall (154) of the semiconductor body (108).
Aspect 4. The photonic chip (102) according to any of aspects 1 to 3, comprising an additional chip waveguide (110) arranged at the semiconductor body (108) and being configured for being directly optically and mechanically coupled with an additional further chip waveguide (150) of the further photonic chip (104) so that, when the additional chip waveguide (110) is directly optically and mechanically coupled with the additional further chip waveguide (150), an additional optical coupling between the photonic chip (102) and the further photonic chip (104) is established.
Aspect 5. The photonic chip (102) according to aspect 4, wherein the chip waveguide (110) and the additional chip waveguide (110) extend parallel to each other along an exterior surface (122) of the semiconductor body (108).
Aspect 6. The photonic chip (102) according to any of aspects 1 to 5, wherein a free end (152) of the chip waveguide (110) has a planar flange face for abutment against a further planar flange face of the further chip waveguide (150).
Aspect 7. The photonic chip (102) according to any of aspects 1 to 5, wherein a free end (152) of the chip waveguide (110) has a non-planar flange face with a waveguide alignment structure (156) for aligned abutment against a further non-planar flange face with a further waveguide alignment structure (158) of the further chip waveguide (150).
Aspect 8. The photonic chip (102) according to aspect 7, wherein the waveguide alignment structure (156) comprises a tapering protrusion or a tapering recess.
Aspect 9. The photonic chip (102) according to any of aspects 1 to 8, wherein a free end (152) of the chip waveguide (110) has a laterally widened section (160).
Aspect 10. The photonic chip (102) according to any of aspects 1 to 9, wherein a sidewall (154) of the semiconductor body (108) has a body alignment structure (162) for aligned abutment against a further body alignment structure (164) of a further semiconductor body (172) of the further photonic chip (104).
Aspect 11. The photonic chip (102) according to aspect 10, wherein the body alignment structure (162) comprises a tapering protrusion or a tapering recess.
Aspect 12. The photonic chip (102) according to any of aspects 1 to 11, wherein the chip waveguide (110) extends between two opposing free ends (152, 166) of the chip waveguide (110) along an exterior surface (122) of the semiconductor body (108).
Aspect 13. The photonic chip (102) according to aspect 12, comprising at least one of the following features: wherein one or both of the two opposing free ends (152, 166) protrudes beyond a respective one of two opposing sidewalls (154, 168) of the semiconductor body (108); wherein one or both of the two opposing free ends (152, 166) is retracted with respect to a respective one of two opposing sidewalls (154, 168) of the semiconductor body (108); wherein one or both of the two opposing free ends (152, 166) is in flush with a respective one of two opposing sidewalls (154, 168) of the semiconductor body (108).
Aspect 14. The photonic chip (102) according to any of aspects 1 to 13, comprising at least one of the following features: wherein the photonic chip (102) comprises at least one integrated circuit element (142) monolithically integrated in the semiconductor body (108); wherein the photonic chip (102) comprises an optoelectronic converter for converting between an electronic domain in the semiconductor body (108) and an optical domain corresponding to the chip waveguide (110); wherein the chip waveguide (110) comprises an optical fiber.
Aspect 15. An arrangement (170), comprising the photonic chip (102) according to any of aspects 1 to 14 and the further photonic chip (104) being directly optically and mechanically coupled or couplable with each other.
Aspect 16. The arrangement (170) according to aspect 15, wherein the further photonic chip (104) is according to any of aspects 1 to 14.
Aspect 17. The arrangement (170) according to aspect 15 or 16, wherein the photonic chip (102) is a bridge die optically coupling the further photonic chip (104) with another photonic chip (106) of the arrangement (170).
Aspect 18. The arrangement (170) according to aspect 17, wherein the other photonic chip (106) is according to any of aspects 1 to 14.
Aspect 19. A method of manufacturing a photonic chip (102), said method comprising: providing a semiconductor body (108); arranging a chip waveguide (110) at the semiconductor body (108); and configuring the chip waveguide (110) for being directly optically and mechanically coupled with a further chip waveguide (150) of a further photonic chip (104) so that, when the chip waveguide (110) is directly optically and mechanically coupled with the further chip waveguide (150), an optical coupling between the photonic chip (102) and the further photonic chip (104) is established.

The above and other objects, features and advantages of the present invention will become apparent from the following description and the appended claims, taken in conjunction with the accompanying drawings, in which like parts or elements are denoted by like reference numbers.

### BRIEF DESCRIPTION OF THE DRAWINGS

The accompanying drawings, which are included to provide a further understanding of exemplary embodiments and constitute a part of the specification, illustrate exemplary embodiments.

### In the drawings:

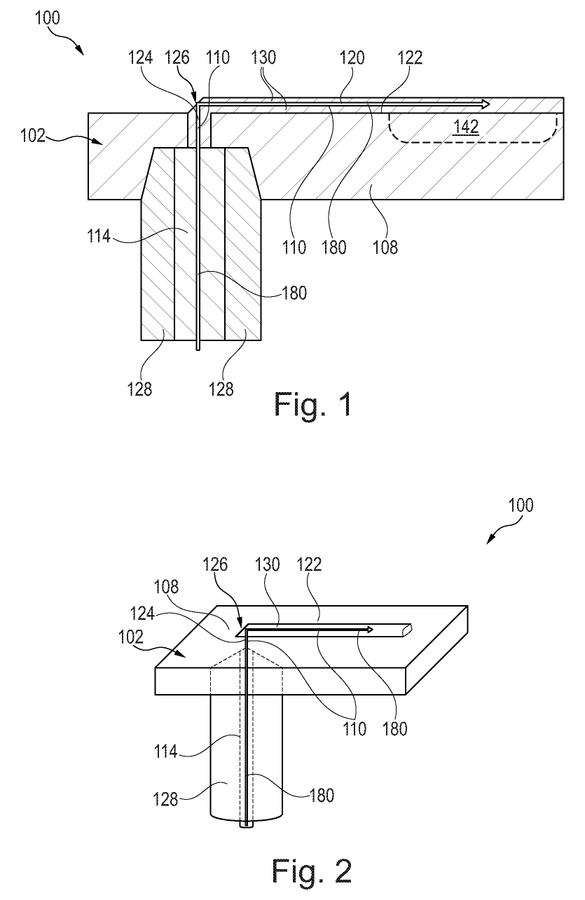

FIG. 1 shows a cross-sectional view of an optoelectronic device according to an exemplary embodiment.

FIG. 2 shows a three-dimensional view of the optoelectronic device according to FIG. 1.

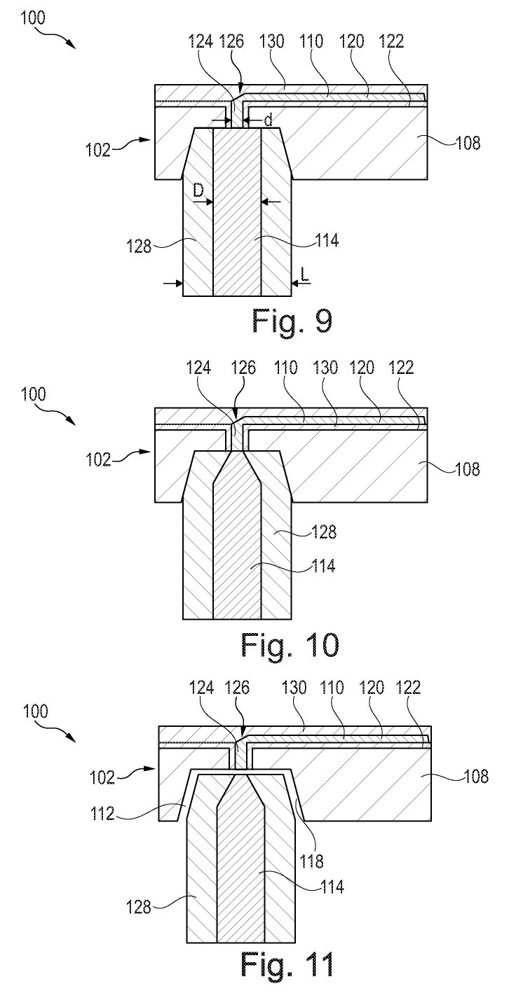

FIGS. 3-9 show cross-sectional views of structures obtained during carrying out a method of manufacturing an optoelectronic device, shown in FIG. 9, according to an exemplary embodiment.

FIG. 10 shows a cross-sectional view of an optoelectronic device according to an exemplary embodiment.

FIG. 11 shows a cross-sectional view of an optoelectronic device according to an exemplary embodiment.

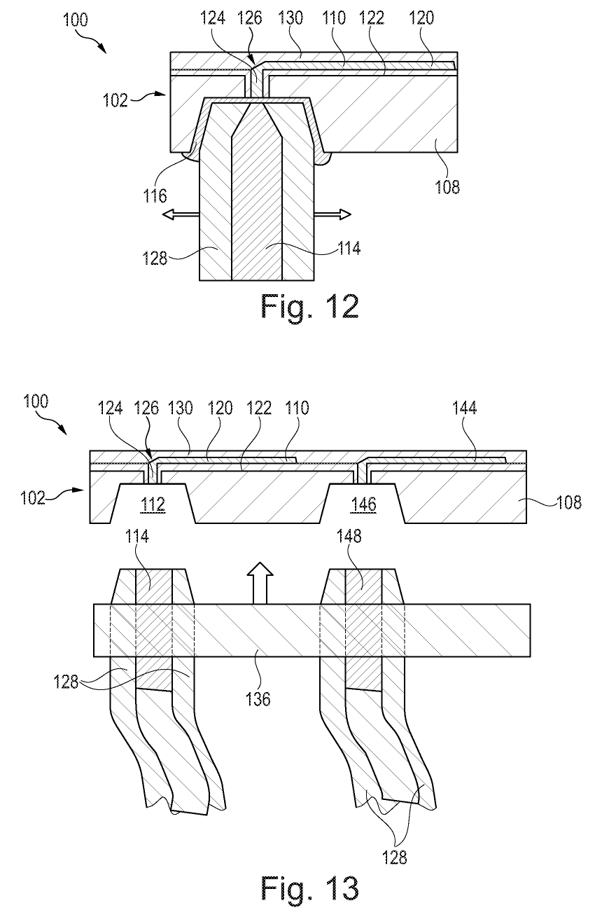

FIG. 12 shows a cross-sectional view of an optoelectronic device according to an exemplary embodiment.

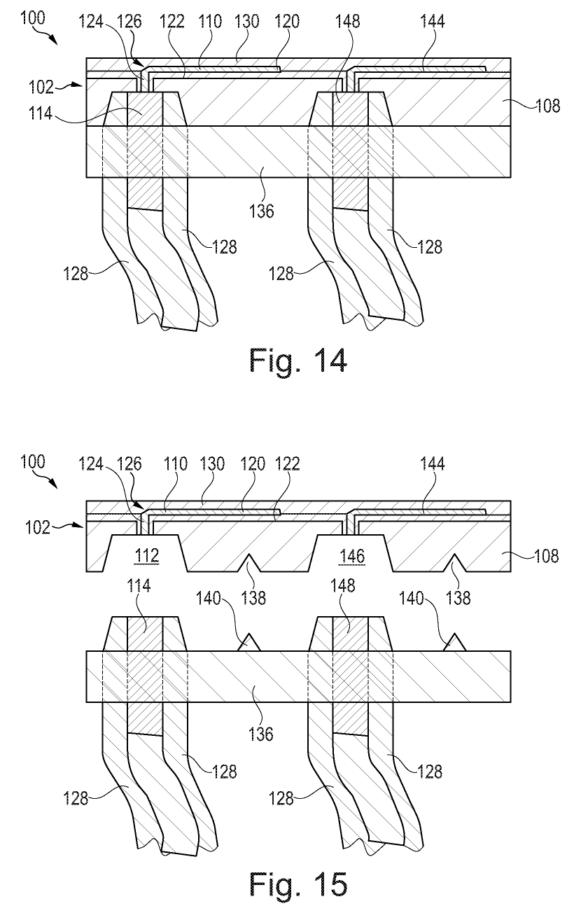

FIGS. 13 and 14 show cross-sectional views of an optoelectronic device according to an exemplary embodiment in different operation states.

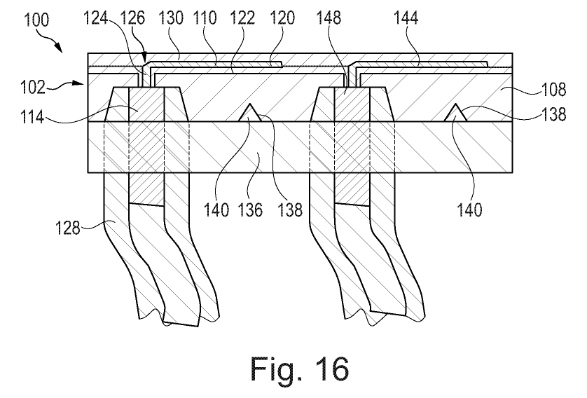

FIGS. 15 and 16 show cross-sectional views of an optoelectronic device according to an exemplary embodiment in different operation states.

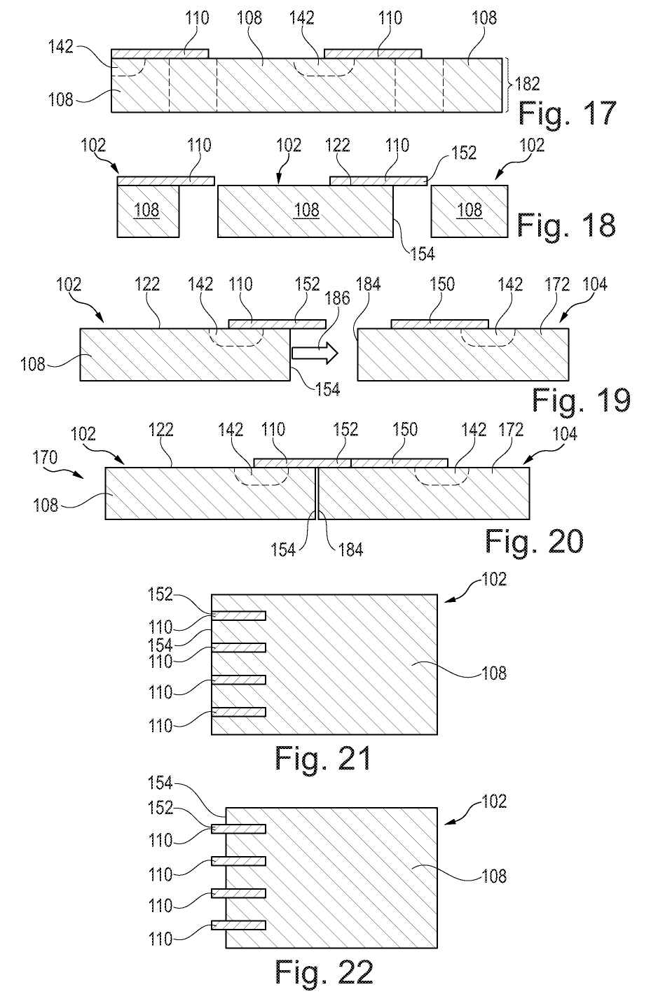

FIGS. 17-20 show cross-sectional views of structures obtained during carrying out a method of manufacturing an arrangement of coupled photonic chips, shown in FIG. 20, according to an exemplary embodiment.

FIG. 21 shows a plan view of a photonic chip according to an exemplary embodiment.

FIG. 22 shows a plan view of a photonic chip according to an exemplary embodiment.

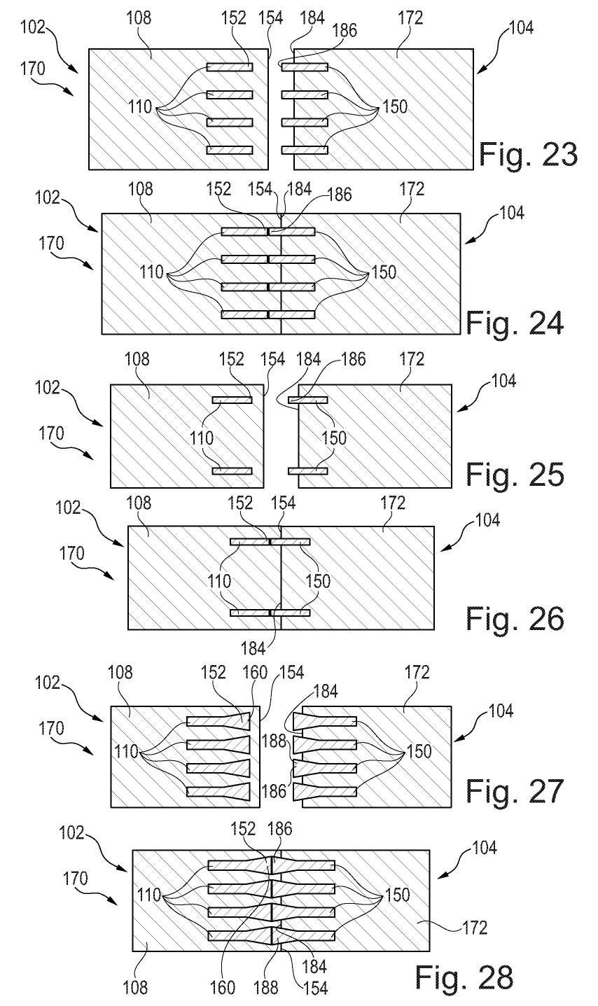

FIGS. 23 and 24 show plan views of an arrangement of photonic chips according to an exemplary embodiment in different operation states.

FIGS. 25 and 26 show plan views of an arrangement of photonic chips according to an exemplary embodiment in different operation states.

FIGS. 27 and 28 show plan views of an arrangement of photonic chips according to an exemplary embodiment in different operation states.

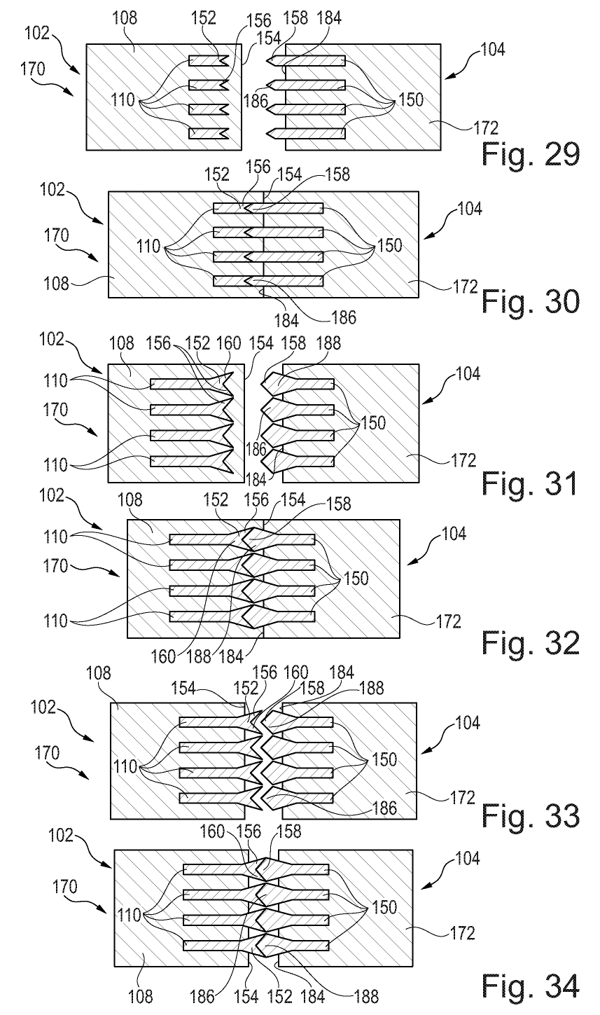

FIGS. 29 and 30 show plan views of an arrangement of photonic chips according to an exemplary embodiment in different operation states.

FIGS. 31 and 32 show plan views of an arrangement of photonic chips according to an exemplary embodiment in different operation states.

FIGS. 33 and 34 show plan views of an arrangement of photonic chips according to an exemplary embodiment in different operation states.

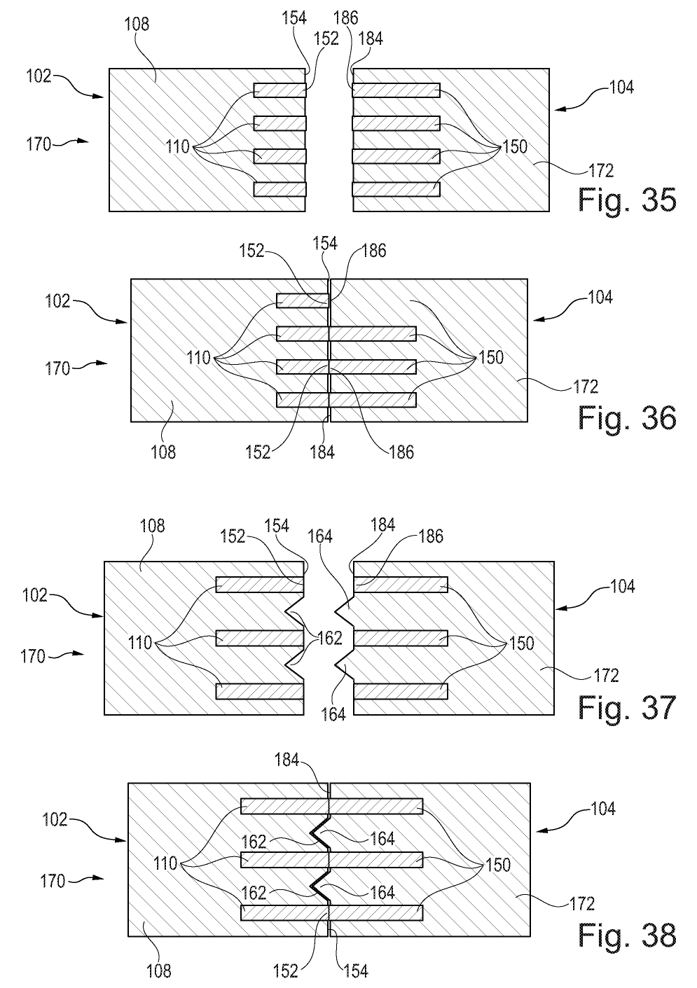

FIGS. 35 and 36 show plan views of an arrangement of photonic chips according to an exemplary embodiment in different operation states.

FIGS. 37 and 38 show plan views of an arrangement of photonic chips according to an exemplary embodiment in different operation states.

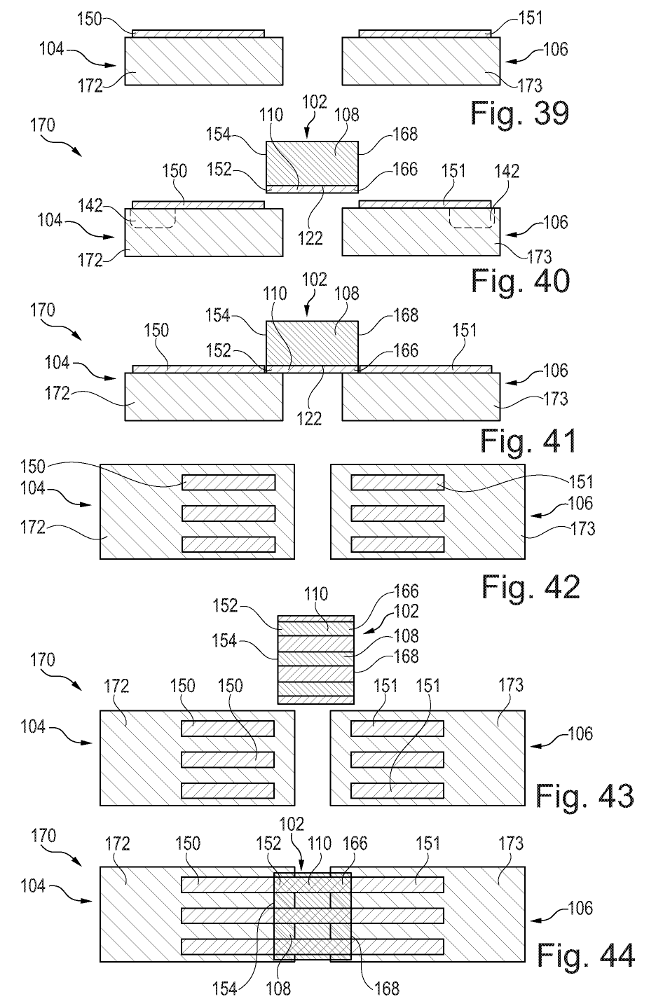

FIGS. 39-41 show cross-sectional views of an arrangement of photonic chips according to an exemplary embodiment in different operation states.

FIGS. 42-44 show plan views of an arrangement of photonic chips according to an exemplary embodiment in different operation states.

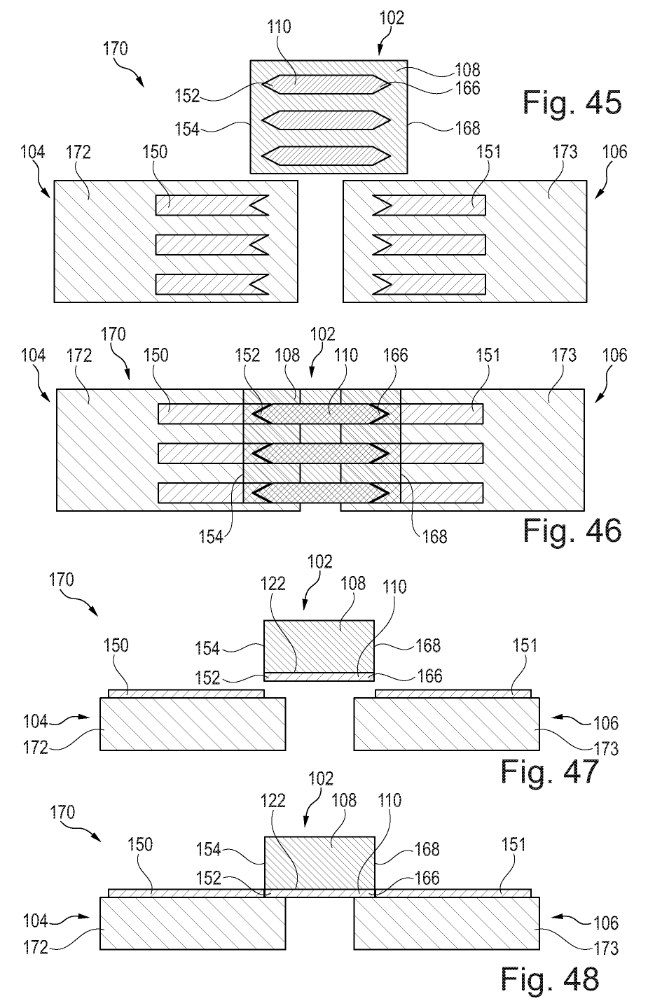

FIGS. 45 and 46 show plan views of an arrangement of photonic chips according to an exemplary embodiment in different operation states.

FIGS. 47 and 48 show cross-sectional views of an arrangement of photonic chips according to an exemplary embodiment in different operation states.

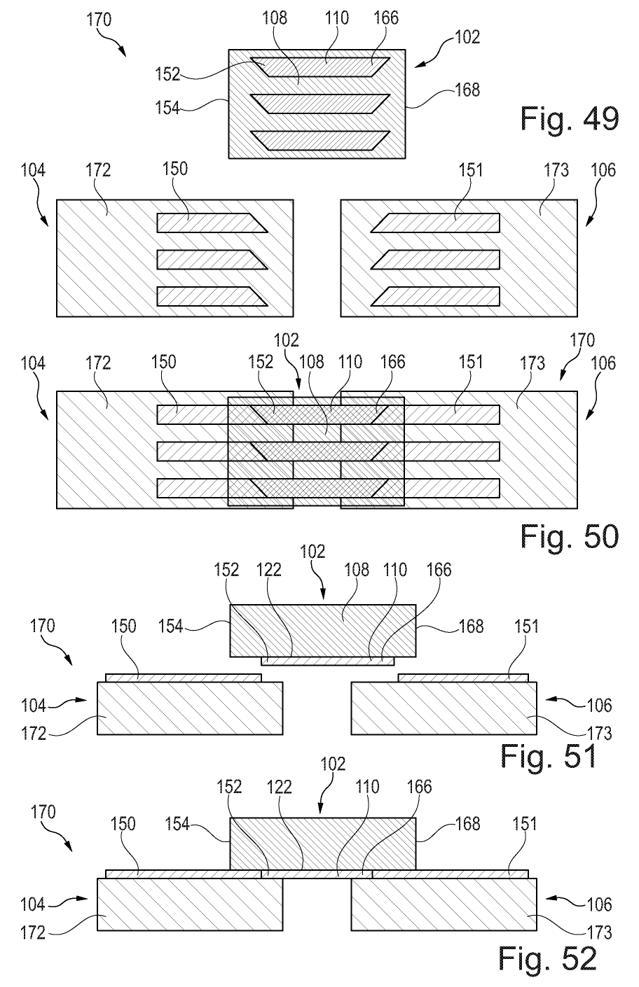

FIGS. 49 and 50 show plan views of an arrangement of photonic chips according to an exemplary embodiment in different operation states.

FIGS. 51 and 52 show cross-sectional views of an arrangement of photonic chips according to an exemplary embodiment in different operation states.

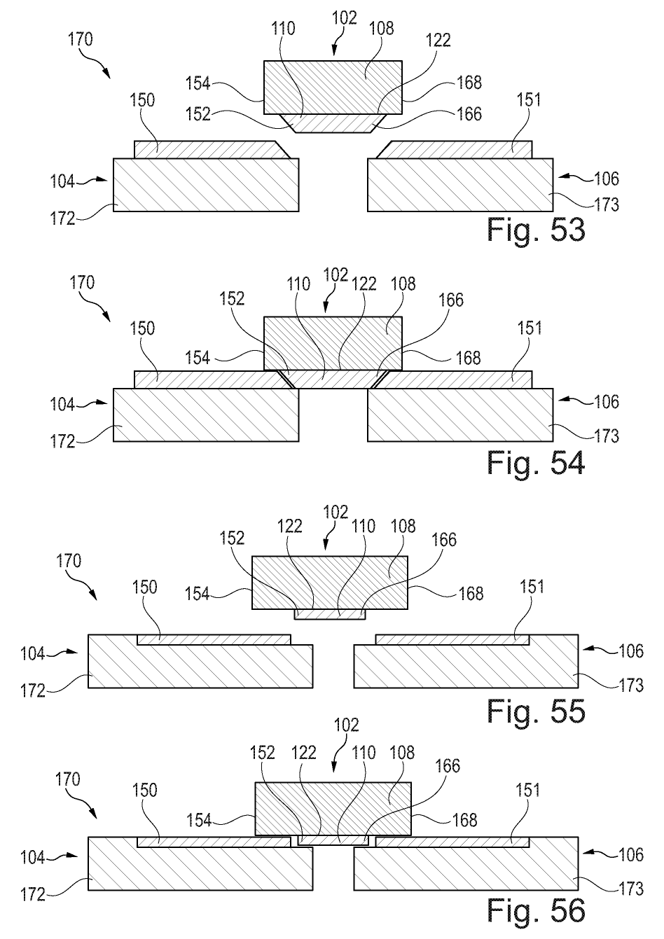

FIGS. 53 and 54 show cross-sectional views of an arrangement of photonic chips according to an exemplary embodiment in different operation states.

FIGS. 55 and 56 show cross-sectional views of an arrangement of photonic chips according to an exemplary embodiment in different operation states.

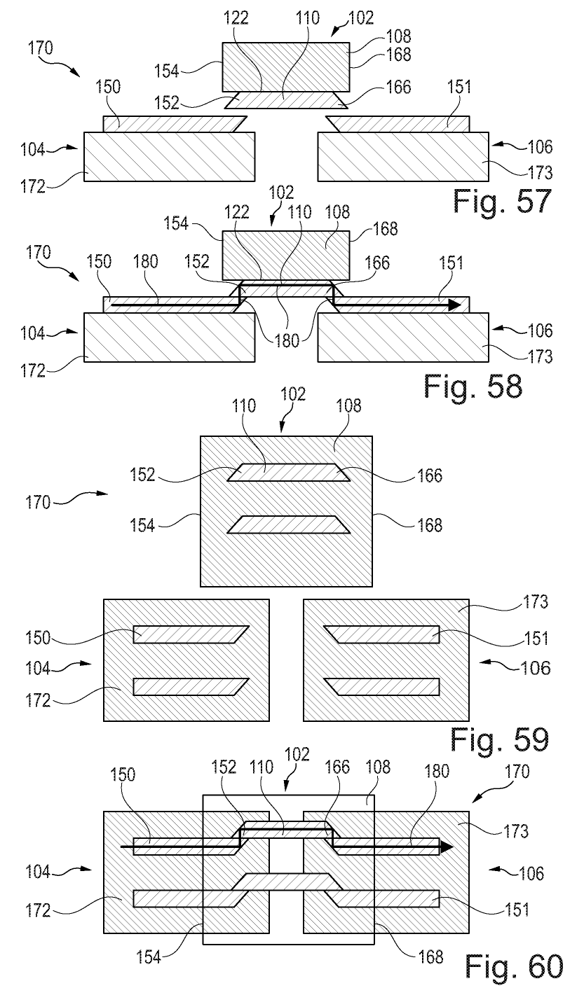

FIGS. 57 and 58 show cross-sectional views of an arrangement of photonic chips according to an exemplary embodiment in different operation states.

FIGS. 59 and 60 show plan views of an arrangement of photonic chips according to an exemplary embodiment in different operation states.

### DETAILED DESCRIPTION

The illustration in the drawing is schematically.

Before describing further exemplary embodiments in further detail, some basic considerations will be summarized based on which exemplary embodiments have been developed.

Optical interconnects between waveguides on different chips may conventionally require an additional fiber in between the chips. This fiber is a macroscopic part. The accurate coupling of the optical signal into the very small waveguides on the chip typically require a high effort. In particular, this may involve a challenging alignment (for instance a passive alignment using V-grooves or additional active alignments with optical feedback during the assembly). Moreover, conventional approaches may require additional optical elements like microlenses, micromirrors, spot size converters or other.

The advancement in optical communication may require more and more interconnects between different photonic integrated circuits (PICs). It is conceivable that PICs with different functions may have to be interconnected.

According to an exemplary embodiment, an optoelectronic device is provided which allows transmission and/or processing of an optical signal. Preferably, such an optical signal may be converted from and/or into an electric domain of the optoelectronic device. At least one photonic chip of the optoelectronic device may be configured for executing tasks such as optical signal transmission, optical signal processing, and/or optical-to-electric and/or electric-to-optical signal conversion. The photonic chip may be equipped with a semiconductor body or substrate (which may be configured in any semiconductor technology, such as silicon technology, silicon carbide technology, gallium nitride technology, etc.). In particular, the semiconductor substrate may have at least one monolithically integrated circuit element. At least one chip waveguide may be provided or formed on and/or in the semiconductor substrate. Said chip waveguide may be configured for guiding optical electromagnetic waves along the photonic chip. Furthermore, a cavity or recess in the semiconductor substrate may be configured for accommodating a chip external waveguide to be optically coupled with the chip waveguide. When such an optical coupling between the waveguides is established, optical signal transmission between photonic chip and chip external waveguide may be initiated. Insertion of a free end of the chip external waveguide into the cavity of the semiconductor body may be sufficient for rendering the optoelectronic device fit for optical signal transmission between an exterior and an interior of the photonic chip. By taking this measure, a fiber-to-chip coupling may be made possible in a very simple way while ensuring simultaneously a short optical signal path. This may ensure a reliable optical coupling and an excellent optical signal transmission quality. For instance, this may also make it possible that PICs with different functions can be interconnected to form one optical device.

According to an exemplary embodiment, an optical chip-to-fiber interconnect may be made possible. In particular, an optical interconnect for a PIC with a PIC-external waveguide may be provided. Advantageously, a direct optical chip-chip external waveguide interconnect may be performed to enable a high signal integrity due to a very short interconnect distance. Beneficially, exemplary embodiments may enable a miniaturization of an optoelectronic device due to small distances from photonic chip to chip external waveguide. Moreover, a back side fiber interconnect may open opportunities for further side-by-side assembly concepts. The front side may correspond to the processed main surface portion of the semiconductor body. Beyond this, exemplary embodiments may allow to omit an active alignment procedure during assembly. Furthermore, exemplary embodiments may provide the opportunity for omitting various additional features and structures, such as additional mirrors, lenses, spot size converters, grating couplers, etc.

According to an exemplary embodiment, it may be possible to attach a chip external waveguide, such as a macroscopic optical fiber, to the back side of a semiconductor body of a photonic chip, to achieve an optical coupling with a microscopic optical fiber of the photonic chip on the front side. Hence, a fiber-to-chip back side coupling architecture may be provided. More specifically, a chip waveguide on the PIC may bend from its lateral extension downwards into a trench. The chip external waveguide, such as an exterior optical fiber, may then be attached into a cavity on the back side of the PIC. Cavity and fiber geometry can be geometrically formed in a way which simplifies the alignment, for instance by providing tapered structures. In an embodiment, multiple chip external waveguides (for instance parallel fibers) may be pre-aligned, for example by using another (for instance bare silicon) die. Also this measure may allow to simplify the assembly. Advantageously, also the photonic chip can have respective alignment structures.

When small gaps occur between adjacent optical structures (such as the chip external waveguide and the semiconductor body of the photonic chip in the cavity) during the assembly, these may be optically acceptable or alternatively they can be closed or filled using a material with optical properties comparable to the waveguides to be optically connected (for instance transparent glue or polymer). However, also mechanical squeezing, soldering, and welding at specific spots on the photonic chip may be possible.

Exemplary applications of exemplary embodiments relate to optical data transmission, in particular for telecommunications system or servers.

FIG. 1 shows a cross-sectional view of an optoelectronic device 100 according to an exemplary embodiment. FIG. 2 shows a three-dimensional view of the optoelectronic device 100 according to FIG. 1. Descriptively speaking, FIGS. 1 and 2 show an optoelectronic device 100 providing an optical fiber-to-photonic chip coupling. In such a configuration, it may be possible to optically couple a chip external waveguide 114, embodied as an optical fiber, from the back side of a semiconductor body 108 of a photonic chip 102 into the photonic chip 102 and with a chip waveguide 110 of the photonic chip 102, for instance via a mirror and/or grating coupler.

The optoelectronic device 100 shown in FIGS. 1 and 2 comprises the photonic chip 102 having semiconductor body 108. The semiconductor body 108 may be a semiconductor substrate, such as a piece of silicon. One or more integrated circuit elements 142 may be monolithically integrated in an active region of a surface portion of the semiconductor body 108. Examples for such integrated circuit elements 142 may be a photodiode, a modulator, a demodulator, an amplifier, a multiplexer, etc. In particular, the integrated circuit elements 142 being monolithically integrated in the semiconductor body 108 may comprise an optoelectronic converter (for instance comprising a photodiode) for converting between an electronic domain in the semiconductor body 108 and an optical domain corresponding to the chip waveguide 110.

The chip waveguide 110 is arranged at the semiconductor body 108 and functions as an optical fiber. The chip waveguide 110 is surrounded by a cladding 130. In particular, it is possible that the chip waveguide 110 is partially or entirely embedded in semiconductor (for example silicon) material of the semiconductor body 108. However, it may also be possible that the chip waveguide 110 is attached to an exterior main surface of the semiconductor body 108. The chip waveguide 110 may be coupled with the integrated circuit elements 142. For instance, an optical signal propagating from the chip waveguide 110 to the integrated circuit elements 142 may be converted there into an electrical signal and may be processed by the integrated circuit elements 142. It may however also be possible that the integrated circuit elements 142 provide an optical signal to the chip waveguide 110 for optical transmission towards the below described chip external waveguide 114.

FIG. 1 illustrates that the chip waveguide 110 comprises an exterior part 120 extending along and on an exterior surface portion of the semiconductor body 108. Moreover, the chip waveguide 110 comprises an interior part 124 extending in an interior of the semiconductor body 108 and being circumferentially delimited by the semiconductor body 108. The exterior part 120 and the interior part 124 of the chip waveguide 110 are integrally formed or integrally connected with each other. More specifically, the exterior part 120 of the chip waveguide 110 extends along an exterior surface 122 of the semiconductor body 108. Furthermore, the interior part 124 of the chip waveguide 110 extends from a below described cavity 112 in the semiconductor body 108 through the semiconductor body 108 up to the exterior surface 122 of the semiconductor body 108. The exterior part 120 and the interior part 124 of the chip waveguide 110 merge in a mutual connection region having a slanted exterior surface. Consequently, the exterior part 120 of the chip waveguide 110 is optically and mechanically coupled with the interior part 124 of the chip waveguide 110 so that a beam 180 of optical light can propagate through the interior part 124 and from there through the exterior part 120, or in opposite direction. As shown in FIGS. 1 and 2 as well, an angled optical interface 126, which may comprise for example the slanted exterior surface can be configured and function as a mirror and/or a grating, optically couples the exterior part 120 of the chip waveguide 110 with the interior part 124 of the chip waveguide 110. Hence, a mirror, grating, grooves and/or a lens may realize the optical transition between the interior part 124 and the exterior part 120 of the chip waveguide 110.

As best seen in FIG. 7, a cavity 112 is formed in the semiconductor body 108. According to FIG. 1, the cavity 112 is formed in the back side of the photonic chip 102, i.e. facing away from the at least one monolithically integrated circuit element 142 in the active region on the front side of the photonic chip 102. However, it is alternatively also possible that the cavity 112 is formed in the front side of the photonic chip 102, i.e. in the main surface also comprising the at least one monolithically integrated circuit element 142 in the active region of the photonic chip 102 (not shown). The cavity 112 extends into the semiconductor body 108 perpendicular to a main surface of the semiconductor body 108. In the illustrated embodiment, the cavity 112 and part of the chip waveguide 110 are arranged at opposing main surfaces of the semiconductor body 108. As shown, said cavity 112 may be a frustoconical recess in the semiconductor body 108. This cavity 112 may be configured, in particular shaped and dimensioned, for accommodating a free end of chip external waveguide 114 surrounded by a cladding 128 therein. Said chip external waveguide 114 including cladding 128 functions as an optical fiber and forms part of the optoelectronic device 100 according to FIGS. 1 and 2.

Said free end of chip external waveguide 114 including cladding 128 may also have a frustoconical shape and dimension corresponding to the frustoconical shape and dimension of the cavity 112 in the semiconductor body 108. The mutually matching geometry of cavity 112 and free end of chip external waveguide 114 including its cladding 128 may be configured so that, when the chip external waveguide 114 is accommodated in the cavity 112, an optical coupling between the chip waveguide 110 and the chip external waveguide 114 is established. Alternatively, the cavity 112 and a free end of the chip external waveguide 114 including a free end of the cladding 128 surrounding the chip external waveguide 114 may have a cylindrical surface, or may be shaped otherwise.

In the illustrated embodiment of FIGS. 1 and 2, part of a bottom surface of the cavity 112 is defined by an end surface of the chip waveguide 110. When the free end of the chip external waveguide 114 abuts against the bottom surface of the cavity 112 at which the end surface of the chip waveguide 110 is exposed, a proper optical coupling between the chip waveguide 110 and the chip external waveguide 114 is established in a simple and failure robust way. When the mechanical and optical coupling between the photonic chip 102 and the chip external waveguide 114 surrounded by cladding 128 is established as shown in FIG. 1, the beam 180 of optical light is enabled to propagate through the chip external waveguide 114 into the chip waveguide 110 and into the at least one integrated circuit element 142, or in opposite direction.

To put it shortly, the embodiment of FIGS. 1 and 2 provides a fiber-to-chip coupling architecture. This embodiment optically and mechanically couples one or more fiber-type chip external waveguides 114 from the back side of the semiconductor body 108 into the photonic chip 102 and into the chip waveguide 110.

FIGS. 3-9 show cross-sectional views of structures obtained during carrying out a method of manufacturing an optoelectronic device 100, shown in FIG. 9, according to an exemplary embodiment.

Referring to FIG. 3, a photonic chip 102 having a semiconductor body 108 may be provided. A trench 144 is formed in a front side of a semiconductor body 108. For example, semiconductor body 108 may comprise silicon. Formation of trench 144 may be accomplished for instance by plasma etching.

Referring to FIG. 4, a surface portion of the front side of the semiconductor body 108 delimiting the trench 144 and a connected surface portion of main surface of semiconductor body 108 may be covered or partially filled with cladding material, which may for instance be deposited. Thus, a portion of a cladding 130 of chip waveguide 110 may be formed in the trench 144 and on a main or exterior surface 122 of the front side of the semiconductor body 108.

Referring to FIG. 5, material of a chip waveguide 110 may be formed on the previously formed portion of cladding 130 so that said material fills a remaining portion of trench 144 and covers at least part of the previously formed portion of the cladding 130. As a result, a pre-form of the chip waveguide 110 is obtained in the portion of the cladding 130 in the trench 144 and on the portion of the cladding 130 on the main surface.

Referring to FIG. 6, the chip waveguide 110 and the portion of the cladding 130 are covered with a remaining portion of the cladding 130.

Referring to FIG. 7, a cavity 112 is formed in the back side of the semiconductor body 108 opposing its front side, for example by etching. During formation of cavity 112, an exposed part of the portion of the cladding 130 in the semiconductor body 108 is removed until the chip waveguide 110 is exposed in the cavity 112. Cavity 112 is designed, for example shaped and dimensioned, for later accommodating a chip external waveguide 114 therein. A free end of the chip waveguide 110 is exposed in the bottom of the cavity 112.

Referring to FIG. 8, the chip external waveguide 114 surrounded by its cladding 128 is inserted in the cavity 112, whereby an optical coupling between the chip waveguide 110 exposed in the bottom of the cavity 112 and an exposed flange face of the chip external waveguide 114 is established.

Referring to FIG. 9, the readily manufactured optoelectronic device 100 is shown.

FIG. 9 illustrates that the chip waveguide 110 has a diameter d which may be less than 1 µm, for instance may be realized by sub-micrometer structures. In contrast to this, the chip external waveguide 114 may have a larger diameter D, for instance a diameter D of 8 µm. More generally, the chip external waveguide 114 may have a diameter D of at least 5 µm. The cladding 128 may have an exterior diameter L of for instance 140 µm.

In the embodiment of FIG. 9, the free end of the chip external waveguide 114 may have a cylindrical shape, and a free end of its cladding 128 may have a frustoconical shape matching with a frustoconical shape of cavity 112.

FIG. 10 shows a cross-sectional view of an optoelectronic device 100 according to an exemplary embodiment. The embodiment of FIG. 10 differs from the embodiment according to FIG. 9 in particular in that, according to FIG. 10 the free end of the chip external waveguide 114 may have a frustoconical shape, and a free end of its cladding 128 may have a frustoconical shape. The chip external waveguide 114 with its cladding 128 abuts against an exposed surface of the semiconductor body 108 and the chip waveguide 110 including its cladding 130 without a gap in between.

FIG. 11 shows a cross-sectional view of an optoelectronic device 100 according to an exemplary embodiment. The embodiment of FIG. 11 differs from the embodiment according to FIG. 10 in particular in that, according to FIG. 11, a lateral and axial gap 118 remains between the chip external waveguide 114 with its cladding 128 on the one hand and an exposed surface of the semiconductor body 108 and the chip waveguide 110 including its cladding 130 on the other hand. Thus, the optical path of a propagating optical light beam 180 (see FIG. 1) comprises a short air portion.

FIG. 12 shows a cross-sectional view of an optoelectronic device 100 according to an exemplary embodiment.

The embodiment of FIG. 12 differs from the embodiment according to FIG. 11 in particular in that, according to FIG. 12, an optically transparent filling medium 116 fills gap 118 between the chip external waveguide 114 with its cladding 128 on the one hand and the semiconductor body 108 as well as chip waveguide 110 including its cladding 130 of the photonic chip 102 on the other hand. For instance, an optically transparent resin may be provided for this purpose.

FIGS. 13 and 14 show cross-sectional views of an optoelectronic device 100 according to an exemplary embodiment in different operation states. In this embodiment, a pre-alignment of fibers can be accomplished by a carrier wafer or chip. The fibers may be pre-assembled through holes in the carrier wafer or chip.

More specifically, the photonic chip 102, in comparison with FIG. 7, further comprises a further chip waveguide 144 (which may be embodied as chip waveguide 110) arranged at the semiconductor body 108, and comprises a further cavity 146 (which may be embodied as cavity 112) in the semiconductor body 108 configured for accommodating a further chip external waveguide 148. Further chip external waveguide 148 may be embodied as chip external waveguide 114, see for instance FIG. 8. Beyond this, an alignment carrier 136 may be provided, which may be for example a semiconductor alignment carrier. As shown, the alignment carrier 136 carries the chip external waveguide 114 including its cladding 128 and the further chip external waveguide 148 including its cladding 128 in an aligning fashion. As a result, the chip external waveguide 114 and the further chip external waveguide 148 are aligned with respect to the cavity 112 and the further cavity 146, respectively. Consequently, when the chip external waveguide 114 is accommodated in the cavity 112 and when simultaneously the further chip external waveguide 148 is accommodated in the further cavity 146, an optical coupling between the chip waveguide 110 and the chip external waveguide 114 is established and simultaneously an optical coupling between the further chip waveguide 144 and the further chip external waveguide 148 is established. Thus, when the chip external waveguide 114 is inserted into the cavity 112, an optical coupling between the chip waveguide 110 and the chip external waveguide 114 is established, and when the further chip external waveguide 148 is simultaneously inserted into the further cavity 146, an optical coupling between the further chip waveguide 144 and the further chip external waveguide 148 is established.

With the architecture according to FIGS. 13 and 14, even complex fiber arrays may be coupled efficiently and precisely with a multi cavity photonic chip.

FIGS. 15 and 16 show cross-sectional views of an optoelectronic device 100 according to an exemplary embodiment in different operation states. Additional alignment structures 138, 140 at the photonic chip 102 and the alignment carrier 136 are foreseen according to FIGS. 15 and 16.

The embodiment of FIGS. 15 and 16 differs from the embodiment according to FIGS. 13 and 14 in particular in that, according to FIGS. 15 and 16 the semiconductor body 108 and the alignment carrier 136 comprise mutually adapted alignment structures 138, 140. In the shown embodiment, alignment structures 138 of photonic chip 102 are embodied as recesses in the semiconductor body 108 and are provided matching to and in alignment with alignment structures 140 of alignment carrier 136 embodied as protrusions. The recesses and the protrusions may also be interchanged. Other kinds of alignment structures 138, 140 are possible as well.

In the following, further exemplary embodiments relating to the above mentioned “aspects” will be described. Any feature of the following embodiments of the aforementioned aspects can be combined with any feature of the embodiments of FIGS. 1-16 and their corresponding description above before the figure description.

According to an exemplary embodiment of said aspects, a photonic chip is provided which comprises a semiconductor body and a chip waveguide arranged at the semiconductor body and being configured for being directly optically and mechanically coupled with a further chip waveguide of a further photonic chip so that, when the chip waveguide is directly optically and mechanically coupled with the further chip waveguide, an optical coupling between the photonic chip and the further photonic chip is established. According to yet another aspect, an arrangement is provided which comprises the photonic chip according to the aforementioned aspect and the further photonic chip being directly optically and mechanically coupled or couplable with each other. According to yet another aspect, a corresponding method of manufacturing a photonic chip is provided. When such an optical coupling between the chip waveguides and the corresponding photonic chips is established, optical signal transmission between the photonic chips may be enabled. Connection of free ends of the chip waveguides with each other may be sufficient for rendering the arrangement fit for optical signal transmission between the directly optically coupled photonic chips. By taking this measure, a chip-to-chip coupling may be made possible in a very simple way while ensuring simultaneously a short optical signal path. This may ensure a reliable optical coupling and an excellent optical signal transmission quality.

According to an exemplary embodiment, an optical chip-to-chip interconnection may be provided allowing to establish optical interconnects for PICs. Such a direct optical chip-chip interconnect may omit an additional fiber. Such aspects may enable miniaturization due to very small distances chip-to-chip. In particular, this may also allow to omit active alignment procedures during assembly. This may also offer opportunities for omitting various additional features and/or structures, such as mirrors, lenses, spot size converters, grating couplers. Furthermore, such an approach may enable the formation of optical chiplets.

In one exemplary embodiment, quilt-type waveguide structures may be implemented to interconnect adjacent PICs. Thus, a quilt-type optical waveguide connection may be provided. Such waveguides may be configured to protrude over the edge of the PIC. It may furthermore be possible to attach optical chips side by side, so that the chip waveguides of adjacent optical chips are in direct or almost direct contact with each other. In particular, it may be possible to provide one or more additional alignment structures in the waveguides themselves and/or in semiconductor (such as silicon) material of the respective photonic chip. Some embodiments of photonic chips omit a protrusion of a chip waveguide beyond a sidewall of the assigned semiconductor body. In such embodiments, it is possible that the waveguide stops at the chip edge. This may be further promoted with a respective alignment of masks for plasma dicing, which may determine the dicing street and the amount of material removed during singulation.

In still another embodiment, it may be possible to use a bridge chip (as a photonic chip) containing one or more waveguides to interconnect two other adjacent photonic chips. Thus, an extra bridge chip may be provided which may contain one or more further chip waveguides to optically interconnect two adjacent photonic chips. The bridge die and/or a respective one of the interconnected photonic chips may further comprise an alignment feature. For instance, different bridge chip sizes and alignment structures may be provided. In yet another embodiment, the chip waveguides on the PICs may be embedded into silicon trenches, in particular so that their top surface is planar with the top surface of the silicon. At the same time, the chip waveguide on the bridge die may protrude over the silicon plane. In such an embodiment, it may be possible to implement more alignment structures on the silicon surfaces. In yet another embodiment, bridge waveguides may be provided which are assembled in an optical path. For example, this can be achieved by a mirror and/or an optical grating in the waveguides, etc. In yet another embodiment, re-routing is implemented within the chip plane. In an embodiment, it may also be possible to mount mechanically adjacent dies on the sidewall to each other, for instance using adhesive material.

FIGS. 17-20 show cross-sectional views of structures obtained during carrying out a method of manufacturing an arrangement 170 of coupled photonic chips 102, 104, shown in FIG. 20, according to an exemplary embodiment. This embodiment relates to a direct chip-to-chip optical connection with a quilt-interconnect architecture for optically connecting optical waveguides. To put it shortly, this embodiment is based on the creation of overhang-waveguide structures at a first photonic chip 102, which later on overlap with a second photonic chip 104.

Referring to FIG. 17, a semiconductor wafer 182 is shown on which a plurality of chip waveguides 110 are formed. For example, a respective chip waveguide 110 may be an optical fiber. The semiconductor wafer 182 may comprise a plurality of still interconnected semiconductor bodies 108. For example, the chip waveguides 110 may be formed by depositing chip waveguide material and cladding material for example as described above referring to FIGS. 4-6. It may be possible that one end portion of each respective chip waveguide 110 is coupled with a respective monolithically integrated circuit element 142, as indicated schematically in FIG. 17. Hence, FIG. 17 shows a processed PIC-semiconductor wafer 182 with chip waveguides 110.

Referring to FIG. 18, the semiconductor wafer 182 with chip waveguides 110 is separated or singulated into a plurality of individual photonic chips 102. Preferably, this can be accomplished by removing semiconductor material (in particular silicon removal) by etching from the back side of the semiconductor wafer 182. In particular, this may be done by plasma etching. To put it shortly, plasma dicing of the semiconductor wafer 182 from its back side may be performed with the chip waveguides 110 functioning as etch stop.

By this process, each respective chip waveguide 110 is configured for being directly optically and mechanically couplable with a further chip waveguide 150 of a further photonic chip 104 in a way as shown in FIG. 19. This configuration can be achieved by removing semiconductor material of the semiconductor wafer 182 so that the respective chip waveguide 110 protrudes laterally beyond a sidewall 154 of its semiconductor body 108. Descriptively speaking, photonic chips 102 (photonic integrated circuits, PIC) with waveguide-protrusion may be obtained. As shown, a plurality of photonic chips 102 can be manufactured on the basis of a common semiconductor wafer 182, see FIG. 18.

Referring to FIG. 19, it is shown that the illustrated chip waveguide 110 of photonic chip 102 is configured for being directly optically and mechanically coupled with a further chip waveguide 150 of a further photonic chip 104. This coupling can be accomplished so that, when the chip waveguide 110 is directly optically and mechanically coupled with the further chip waveguide 150, an optical coupling between the photonic chip 102 and the further photonic chip 104 is established. As can be taken from FIG. 19, the further chip waveguide 150 of the further photonic chip 104 is laterally retracted with respect to a sidewall 184 of a further semiconductor body 172 of the further photonic chip 104. For instance, also the further photonic chip 104 may comprise a monolithically integrated circuit element 142 in a surface portion or active region of a front side of its semiconductor body 172. When the photonic chips 102, 104 are connected mutually by a motion according to reference sign 186 in FIG. 19, facing lateral flange faces of the chip waveguides 110, 150 may abut against each other for establishing a mutual optical coupling. For example, abutment of the lateral flange faces of the chip waveguides 110, 150 may occur simultaneously with an abutment of the sidewalls 154, 184 of the semiconductor bodies 108, 172 of the photonic chips 102, 104. For instance, a direct physical contact may be established between the lateral flange faces of the chip waveguides 110, 150 and/or between the sidewalls 154, 184 of the semiconductor bodies 108, 172.

Referring to FIG. 20, the optical chip-to-optical chip coupling between photonic chip 102 and further photonic chip 104 is completed, so that an arrangement 170 of optically and mechanically coupled photonic chips 102, 104 is obtained. When the photonic chips 102, 104 are coupled with each other, their chip waveguides 110, 150 are optically coupled with each other, and also their integrated circuits 142 may be communicatively coupled with each other by optical signal transmission via the chip waveguides 110, 150. Hence, FIG. 20 shows an optical chip-to-optical chip assembly of photonic chips 102, 104 arranged side by side in an optically coupled state.

FIG. 21 shows a plan view of a photonic chip 102 according to an exemplary embodiment.

The illustrated photonic chip 102 comprises a semiconductor body 108, such as a silicon substrate. A monolithically integrated circuit (not shown in FIG. 21, see reference sign 142 above) may be formed in a surface portion or an active region of the semiconductor body 108. Furthermore, an array of chip waveguides 110 is arranged at a top main surface of the semiconductor body 108. In the shown embodiment, four chip waveguides 110 extend in parallel. It is however also possible to provide two, three or at least five chip waveguides 110 at photonic chip 102. In yet another embodiment, only a single chip waveguide 110 is arranged at a main surface of the semiconductor body 108 of the photonic chip 102.

Now also referring to FIGS. 35 and 36, each chip waveguide 110 is configured for being directly optically and mechanically coupled with an assigned further chip waveguide 150 of a further photonic chip 104. This configuration may be so that, when the chip waveguides 110 are directly optically and mechanically coupled with the further chip waveguides 150, an optical coupling between the photonic chip 102 and the further photonic chip 104 is established, compare FIG. 36. In the embodiment of FIGS. 21, 35 and 36, an optical connection between all respective chip waveguides 110 and further chip waveguides 150 is established simultaneously, in particular by bringing the facing sidewalls 154, 184 of the semiconductor bodies 108, 172 of the photonic chips 102, 140 in abutment.

All the chip waveguides 110 extend parallel to each other. All the further chip waveguides 150 extend parallel to each other. When the photonic chips 102, 104 are mechanically and optically connected, the chip waveguides 110 and the further chip waveguides 150 extend parallel to each other. In the connected state of photonic chips 102, 104, free ends 152 of the chip waveguides 110 have a planar flange face abutting against further planar flange faces of free ends 186 of the further chip waveguides 150, see FIGS. 35 and 36.

In the embodiment of FIG. 21, chip waveguide 110 is arranged along its entire longitudinal extension on the main surface of the semiconductor body 108. A lateral coupling end of chip waveguides 110 is in flush with the sidewall 154 of the semiconductor body 108. In other words, a flange face of free end 152 of each of the chip waveguides 110 is in flush with sidewall 154 of the semiconductor body 108.

FIG. 22 shows a plan view of a photonic chip 102 according to an exemplary embodiment.

The embodiment of FIG. 22 differs from the embodiment of FIG. 21 in particular in that, according to FIG. 22 a free end 152 of the chip waveguides 110 protrudes or extends beyond sidewall 154 of the semiconductor body 108. A coupling of such laterally protruding chip waveguides with laterally retracted further chip waveguides of a further photonic chip is illustrated in FIGS. 23 and 24.

FIGS. 23 and 24 show plan views of an arrangement 170 of photonic chips 102, 104 according to an exemplary embodiment in different operation states.

Referring to FIG. 23, a photonic chip 102 according to FIG. 22 is shown laterally spaced with respect to a further photonic chip 104. Photonic chip 102 of FIG. 23 has chip waveguides 110 having a free end 152 which is retracted with respect to a sidewall 154 of the semiconductor body 172. Further photonic chip 104 of FIG. 23 has further chip waveguides 150 having a free end 186 which is protruding beyond a sidewall 184 of the further semiconductor body 172.

Referring to FIG. 24, an arrangement 170 according to an exemplary embodiment is shown which comprises the photonic chip 102 and the further photonic chip 104 of FIG. 23 being now directly optically and mechanically coupled with each other. Sidewalls 154, 184 may now be in direct physical contact with each other and/or flange faces of free ends 152, 186. To put it shortly, FIG. 24 shows an optical butt-coupling between photonic chips 102, 104.

FIGS. 25 and 26 show plan views of an arrangement 170 of photonic chips 102, 104 according to an exemplary embodiment in different operation states. The embodiment of FIGS. 25 and 26 differs from the embodiment of FIGS. 23 and 24 in particular in that, according to FIGS. 25 and 26 two (rather than four) chip waveguides 110 and further chip waveguides 150 are provided. Any numbers of chip waveguides 110, 150 is possible.

FIGS. 27 and 28 show plan views of an arrangement 170 of photonic chips 102, 104 according to an exemplary embodiment in different operation states. This embodiment shows waveguide coupling with increased interface area.

The embodiment of FIGS. 27 and 28 differs from the embodiment of FIGS. 23 and 24 in particular in that, according to FIGS. 27 and 28 free ends 152 of the chip waveguide 110 have a laterally widened section 160 and free ends 186 of the further chip waveguides 150 have a laterally widened section 188. Such widened sections 160, 188 may improve the efficiency of the optical transmission from waveguides 110 to further waveguides 150, or vice versa. The embodiment of FIGS. 27 and 28 may be denoted as butt-coupling with increased interface area.

FIGS. 29 and 30 show plan views of an arrangement 170 of photonic chips 102, 104 according to an exemplary embodiment in different operation states. This embodiment shows waveguide coupling with alignment structures.

The embodiment of FIGS. 29 and 30 differs from the embodiment of FIGS. 23 and 24 in particular in that, according to FIGS. 29 and 30 a free end 152 of the chip waveguides 110 has a non-planar flange face with a waveguide alignment structure 156 for aligned abutment against a further non-planar flange face with a further waveguide alignment structure 158 of the further chip waveguides 150. As shown, the waveguide alignment structure 156 comprises a tapering recess, whereas the further waveguide alignment structure 158 comprises a tapering protrusion matching with the tapering recess. In other words, a form closure may be established between the waveguide alignment structures 156 and the further waveguide alignment structures 158 when in engagement with each other. The mutually adapted waveguide alignment structures 156, 158 may improve the reliability of the alignment between the photonic chips 102, 104.

FIGS. 31 and 32 show plan views of an arrangement 170 of photonic chips 102, 104 according to an exemplary embodiment in different operation states. The embodiment of FIGS. 31 and 32 combine the increased interface area provided by the widened sections 160, 188 of the embodiment of FIGS. 27 and 28 with alignment structures 156, 158 at the free ends 152, 186 of the chip waveguides 110 and the further chip waveguides 150 of FIGS. 29 and 30. In other words, the embodiment of FIGS. 31 in 32 provides chip waveguide alignment structures on an increased interface area.

In an advantageous embodiment, the alignment structures 156, 158 can as well be configured to involve lens (for example focusing) effects on a propagating optical light beam 180.

FIGS. 33 and 34 show plan views of an arrangement 170 of photonic chips 102, 104 according to an exemplary embodiment in different operation states. The embodiment of FIGS. 33 and 34 differs from the embodiment of FIGS. 31 and 32 in particular in that, according to FIGS. 33 and 34, an overhang of chip waveguides 110, 150 beyond respective sidewalls 154, 184 of a respective semiconductor body 108, 172 is provided on both sides or on both photonic chips 102, 104.

FIGS. 35 and 36 show plan views of an arrangement 170 of photonic chips 102, 104 according to an exemplary embodiment in different operation states. This embodiment has already been mentioned referring to the description of FIG. 21. The arrangement 170 of FIGS. 35 and 36 relates to flush fitting of chip waveguides 110, 150 without any lateral overhang of chip waveguides 110, 150 beyond a respective sidewall 154, 158 of a respective semiconductor body 108, 172.

FIGS. 37 and 38 show plan views of an arrangement 170 of photonic chips 102, 104 according to an exemplary embodiment in different operation states. The embodiment of FIGS. 37 and 38 differs from the embodiment of FIGS. 35 and 36 in particular in that, according to FIGS. 37 and 38, sidewall 154 of the semiconductor body 108 of photonic chip 102 has a body alignment structure 162 for aligned abutment against a further body alignment structure 164 at sidewall 184 of further semiconductor body 172 of the further photonic chip 104. As shown, the body alignment structure 162 comprises a tapering recess, whereas the further body alignment structure 164 comprises a tapering protrusion matching with the tapering recess. In other words, a form closure may be established between the body alignment structure 162 and the further body alignment structure 164 when in engagement with each other. The mutually adapted body alignment structure 162, 164 may improve the reliability of the alignment between the photonic chips 102, 104. Hence, the described embodiment may provide alignment structures in silicon. The embodiment of FIGS. 37 and 38 combines alignment structures 162, 164 in silicon (which may be formed for instance by plasma dicing) and a straight butt-coupling of the chip waveguides 110, 150.

Furthermore, the embodiment of FIGS. 37 and 38 shows three pairs of chip waveguides 110, 150, rather than four pairs. Any other number is possible.

FIGS. 39-41 show cross-sectional views of an arrangement 170 of photonic chips 102, 104, 106 according to an exemplary embodiment in different operation states. FIGS. 42-44 show corresponding plan views of said arrangement 170. Descriptively speaking, this embodiment may be denoted as an optical chip-to-optical chip-versus bridge die coupling. In other words, an optical bridge die, which may be a photonic chip 102, may be used for optically interconnecting two other photonic chips 104, 106 with each other. For example, such a bridge die may contain one or more respective chip waveguides 110 and optionally alignment structures. Such an embodiment has the advantage that no overhangs of portions of chip waveguides 110, 150, 151 beyond a sidewall of a semiconductor body 108, 172, 173 are necessary, which may improve the mechanical handling of the photonic chips 102, 104, 106.

Referring to FIGS. 39 and 42, further photonic chip 104 and other photonic chip 106, which are to be optically coupled with each other, are arranged side-by-side.

Referring to FIGS. 40 and 43, the optically coupling photonic chip 102, which is configured as an optical bridge die for optically coupling the further photonic chip 104 with the other photonic chip 106 of the arrangement 170, is shown as well. The chip waveguide 110 of an optical bridge die-type photonic chip 102 extends between two opposing free ends 152, 166 of the chip waveguide 110 and along an exterior surface 122 of the semiconductor body 108 of the photonic chip 102. Both of the two opposing free ends 152, 166 of chip waveguide 110 is in flush with a respective one of two opposing sidewalls 154, 168 of the semiconductor body 108.

Semiconductor body 108 of photonic chip 102 may also comprise at least one monolithically integrated circuit element (which may be coupled with the chip waveguide 110), or may be free of such a monolithically integrated circuit element.

Further photonic chip 104 has a further semiconductor body 172 and a further chip waveguide 150 extending along a main surface thereof. A free coupling end of further chip waveguide 150 is retracted with respect to a coupling sidewall of further semiconductor body 172. It is also possible that at least one monolithically integrated circuit element 142 is monolithically integrated in a surface portion or active region of the further semiconductor body 172. Integrated circuit element 142 may also be optoelectronically coupled with an optoelectronic end of the further chip waveguide 150.

Correspondingly, the other photonic chip 106 has another semiconductor body 173 and another chip waveguide 151 extending along a main surface thereof. A free coupling end of the other chip waveguide 151 is retracted with respect to a coupling sidewall of the other semiconductor body 173. It is also possible that at least one monolithically integrated circuit element 142 is monolithically integrated in a surface portion or active region of the other semiconductor body 173. Integrated circuit element 142 may also be optoelectronically coupled with an optoelectronic end of the other chip waveguide 151.

Referring to FIGS. 41 and 44, the bridge die-type photonic chip 102 has being mechanically and optically connected between the further photonic chip 104 and the other photonic chip 106. More specifically, this coupling has been accomplished so that a flange face of coupling end of further chip waveguide 150 faces or is even abutting a flange face of free end 152 of chip waveguide 110 and so that a flange face of coupling end of other chip waveguide 151 faces or is even abutting a flange face of opposing free end 166 of chip waveguide 110. In this coupling stage, all chip waveguides 150, 110, 151 are aligned with each other so as to form a straight optical propagation path. End portions of the chip waveguide 110 may lie on main surface portions of semiconductor bodies 172, 173. In the optically coupled configuration of FIGS. 41 and 44, it may be possible that the monolithically integrated circuit elements 142, 142 of the photonic chips 104, 106 are communicatively coupled for optical communication via chip waveguides 150, 110, 151.

The photonic chip 102 may also be permanently fixed to further photonic chip 104 and other photonic chip 106, for instance by gluing.

FIGS. 45 and 46 show plan views of an arrangement 170 of photonic chips 102, 104, 106 according to an exemplary embodiment in different operation states. FIGS. 47 and 48 show corresponding cross-sectional views of said arrangement 170. The embodiment of FIGS. 45-48 differs from the embodiment of FIGS. 39-44 in particular in that, according to FIGS. 45-48 a free end 152 of the chip waveguides 110 has a non-planar flange face with a waveguide alignment structure for aligned abutment against a further non-planar flange face with a further waveguide alignment structure of the further chip waveguides 150. Furthermore, an opposing free end 166 of the chip waveguides 110 has a non-planar flange face with a waveguide alignment structure for aligned abutment against another non-planar flange face with another waveguide alignment structure of the other chip waveguides 151. As shown, the waveguide alignment structures of chip waveguides 150, 151 comprise a tapering recess, whereas the waveguide alignment structures on both opposing free ends 152, 166 of the chip waveguides 110 comprise a tapering protrusion matching with the tapering recess. In other words, a form closure may be established between the waveguide alignment structures of the chip waveguides 110 and the waveguide alignment structures of the chip waveguides 150, 151 when in engagement with each other. The mutually adapted waveguide alignment structures may improve the reliability of the alignment between the photonic chips 102, 104, 106. Hence, FIGS. 45-48 show advantageous geometries of waveguide couplings.

FIGS. 49 and 50 show plan views of an arrangement 170 of photonic chips 102, 104, 106 according to an exemplary embodiment in different operation states. FIGS. 51 and 52 show corresponding cross-sectional views of said arrangement 170. The embodiment of FIGS. 49-52 differs from the embodiment of FIGS. 45-48 in particular in that, according to FIGS. 49-52, the free ends 152, 166 of the chip waveguides 110 have a non-planar flange face with a waveguide alignment structure comprising a tapering triangular protrusion, whereas corresponding waveguide alignment structures of the chip waveguides 150, 151 also have tapering triangular protrusions. When in engagement with each other, the tapering triangular protrusions of the waveguides 110, 150, 151 match to each other and provide together an overall waveguide structure having a constant diameter over its entire extension. The mutually adapted waveguide alignment structures may improve the reliability of the alignment between the photonic chips 102, 104, 106.

Moreover, the chip waveguides 110 on the semiconductor body 108 of the bridge die-type photonic chip 102 are retracted at both opposing free ends 152, 166 with respect to an adjacent sidewall 154, 168 of the semiconductor body 108. Thus, both of the two opposing free ends 152, 166 of photonic chip 102 are retracted with respect to a respective one of two opposing sidewalls 154, 168 of the semiconductor body 108. By making the bridge die-type photonic chip 102 larger than its chip waveguide extension, manufacturing and assembly of the bridge die may be simplified.

FIGS. 53 and 54 show cross-sectional views of an arrangement 170 of photonic chips 102, 104, 106 according to an exemplary embodiment in different operation states. FIG. 53 shows arrangement 170 before establishing an optical and mechanical connection between photonic chips 102, 104, 106, and FIG. 54 shows arrangement 170 after having established an optical and mechanical connection between photonic chips 102, 104, 106. The embodiment of FIGS. 53 and 54 differs from the embodiment of FIGS. 40 and 41 in particular in that, according to FIGS. 53 and 54, waveguide alignment structures are formed at assigned free ends of chip waveguides 110, 150, 151 for promoting alignment in a vertical direction, i.e. perpendicular to the extension of the chip waveguides 110, 150, 161. When lowering photonic chip 102 onto photonic chips 104, 106 based on the initial position according to FIG. 53 towards the final position according to FIG. 54, the vertically acting chip waveguide alignment structures lead to a self-alignment of the photonic chips 102, 104, 106 relatively to each other. Said chip waveguide alignment structures of the corresponding free ends of photonic chips 102, 104, 106 taper in a vertical direction. In particular, free ends 152, 156 of chip waveguide 110 of photonic chip 102 taper away from semiconductor body 108. Correspondingly, free connection ends of chip waveguides 150, 151 of photonic chips 104, 106 taper away from semiconductor bodies 172, 173. The geometries of the waveguide couplings have alignment structures focusing in a vertical direction perpendicular to a chip plane.

FIGS. 55 and 56 show cross-sectional views of an arrangement 170 of photonic chips 102, 104, 106 according to an exemplary embodiment in different operation states. The embodiment of FIGS. 55 and 56 differs from the embodiment of FIGS. 51 and 52 in particular in that, according to FIGS. 55 and 56 , chip waveguide 150 is embedded or downset in a surface recess of semiconductor body 172 so that an exterior surface of the chip waveguide 150 is in alignment with an exterior main surface of recessed semiconductor body 172. Correspondingly, chip waveguide 151 is embedded or downset in a surface recess of semiconductor body 173 so that an exterior surface of the chip waveguide 151 is in alignment with an exterior main surface of recessed semiconductor body 173. Thus, chip waveguides 150, 151 and semiconductor surface of semiconductor bodies 172, 173 are in plane, since the respective chip waveguides 150, 151 are embedded (or downset) into a semiconductor trench.

At the bridge die-type photonic chip 102 however, the chip waveguide 110 is exposed and is protruding as a three-dimensional structure. Hence, alignment features can also be provided at the level of the semiconductor bodies 172, 173.

FIGS. 57 and 58 show cross-sectional views of an arrangement 170 of photonic chips 102, 104, 106 according to an exemplary embodiment in different operation states. The embodiment of FIGS. 57 and 58 differs from the embodiment of FIGS. 53 and 54 in particular in that, according to FIGS. 57 and 58, waveguide alignment structures are formed at assigned free ends of chip waveguides 110, 150, 151 for creating vertical reflection mirrors of interconnected chip waveguides 110, 150, 151 of photonic chips 102, 104, 106. In particular, free ends 152, 156 of chip waveguide 110 of photonic chip 102 tapers towards semiconductor body 108. Correspondingly, free connection ends of chip waveguides 150, 151 of photonic chips 104, 106 taper towards the semiconductor bodies 172, 173. As can be taken from FIG. 58, an optical light beam 180 propagating along chip waveguides 150, 110, 151 can be reflected at slanted surfaces of the resulting combined chip waveguide structure. Such an optical coupling may also create mirror or grate couplings in certain embodiments.

FIGS. 59 and 60 show cross-sectional views of an arrangement 170 of photonic chips 102, 104, 106 according to an exemplary embodiment in different operation states. The embodiment of FIGS. 59 and 60 differs from the embodiment of FIGS. 57 and 58 in particular in that, according to FIGS. 59 and 60, waveguide alignment structures are formed at assigned free ends of chip waveguides 110, 150, 151 for creating planar reflection mirrors of interconnected chip waveguides 110, 150, 151 of photonic chips 102, 104, 106. In particular, free ends 152, 156 of chip waveguide 110 of photonic chip 102 tapers in the plane of a main surface of the semiconductor body 108. Correspondingly, free connection ends of chip waveguides 150, 151 of photonic chips 104, 106 taper in the plane of a main surface of the semiconductor bodies 172, 173. As can be taken from FIG. 60, an optical light beam 180 propagating along chip waveguides 150, 110, 151 can be reflected at slanted surfaces of the resulting combined chip waveguide structure. Such an optical coupling may also create mirror or grate couplings in certain embodiments.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

It should be noted that the term “comprising” does not exclude other elements or features and the “a” or “an” does not exclude a plurality. Also elements described in association with different embodiments may be combined. It should also be noted that reference signs shall not be construed as limiting the scope of the claims. Moreover, the scope of the present application is not intended to be limited to the particular embodiments of the process, machine, manufacture, composition of matter, means, methods and steps described in the specification. Accordingly, the appended claims are intended to include within their scope such processes, machines, manufacture, compositions of matter, means, methods, or steps.

What is claimed is:

1. An optoelectronic device comprising a photonic chip, the photonic chip comprising:
a semiconductor body;
a chip waveguide arranged at the semiconductor body; and
a cavity in the semiconductor body and configured to accommodate a chip external waveguide so that, when the chip external waveguide is accommodated in the cavity, an optical coupling between the chip waveguide and the chip external waveguide is established.

2. The optoelectronic device of claim 1, further comprising the chip external waveguide inserted into the cavity so that the optical coupling between the chip waveguide and the chip external waveguide is established.

3. The optoelectronic device of claim 2, further comprising an optically transparent filling medium at least partially filling a gap between the chip external waveguide and the photonic chip.

4. The optoelectronic device of claim 1, wherein an exterior part of the chip waveguide extends along an exterior surface of the semiconductor body.

5. The optoelectronic device of claim 1, wherein an interior part of the chip waveguide extends from the cavity through the semiconductor body up to an exterior surface of the semiconductor body.

6. The optoelectronic device of claim 5, wherein an exterior part of the chip waveguide extends along an exterior surface of the semiconductor body, and wherein the exterior part of the chip waveguide is optically and mechanically coupled with the interior part of the chip waveguide.

7. The optoelectronic device of claim 6, further comprising an angled optical interface comprising a mirror and/or a grating, wherein the angled optical interface optically couples the exterior part of the chip waveguide with the interior part of the chip waveguide.

8. The optoelectronic device of claim 1, wherein at least one of:
the chip waveguide has a diameter of less than 1 µm;
the chip external waveguide has a diameter of at least 5 µm;
the chip external waveguide is surrounded by a cladding; and
the chip waveguide is surrounded by a cladding.

9. The optoelectronic device of claim 1, wherein the cavity and/or a free end of the chip external waveguide and/or a free end of a cladding surrounding the chip external waveguide has a frustoconical surface or has a cylindrical surface.

10. The optoelectronic device of claim 1, wherein part of a bottom surface of the cavity is defined by an end surface of the chip waveguide.

11. The optoelectronic device of claim 1, wherein the cavity extends into the semiconductor body perpendicular to a main surface of the semiconductor body.

12. The optoelectronic device of claim 1, wherein the cavity and part of the chip waveguide are arranged at opposing main surfaces of the semiconductor body.

13. The optoelectronic device of claim 1, wherein the photonic chip further comprises:
a further chip waveguide arranged at the semiconductor body; and
a further cavity in the semiconductor body and configured to accommodate a further chip external waveguide so that, when the further chip external waveguide is accommodated in the further cavity, an optical coupling between the further chip waveguide and the further chip external waveguide is established.

14. The optoelectronic device of claim 13, wherein:
the chip external waveguide is inserted into the cavity so that the optical coupling between the chip waveguide and the chip external waveguide is established; and
the further chip external waveguide is inserted into the further cavity so that the optical coupling between the further chip waveguide and the further chip external waveguide is established.

15. The optoelectronic device of claim 14, further comprising an alignment carrier carrying the chip external waveguide and the further chip external waveguide, so that the chip external waveguide is aligned with respect to the cavity and the further chip external waveguide is aligned with respect to the further cavity.

16. The optoelectronic device of claim 15, wherein the semiconductor body and the alignment carrier comprise mutually adapted alignment structures.

17. The optoelectronic device of claim 1, wherein at least one of:
the photonic chip further comprises at least one integrated circuit element monolithically integrated in the semiconductor body;
the photonic chip further comprises an optoelectronic converter configured to convert between an electronic domain in the semiconductor body and an optical domain corresponding to the chip waveguide;
at least one of the chip waveguide and the chip external waveguide comprises an optical fiber; and
the cavity is formed in a front side or in a back side of the photonic chip.

18. A method of manufacturing an optoelectronic device, the method comprising:
providing a photonic chip having a semiconductor body;
arranging a chip waveguide at the semiconductor body; and
forming a cavity in the semiconductor body for accommodating a chip external waveguide so that, when the chip external waveguide is accommodated in the cavity, an optical coupling between the chip waveguide and the chip external waveguide is established.

19. The method of claim 18, further comprising:
forming a trench in the semiconductor body;
forming a portion of a cladding in the trench and on a main surface of the semiconductor body;
forming the chip waveguide on the portion of the cladding in the trench and on the portion of the cladding on the main surface; and
covering the chip waveguide and the portion of the cladding with a remaining portion of the cladding.

20. The method of claim 19, further comprising removing part of the portion of the cladding in the trench during forming the cavity in the semiconductor body until the chip waveguide is exposed in the cavity.
